(19) United States
(12) Patent Application Publication
(10) Pub. No.: US 2015/0248405 A1
(43) Pub. Date: Sep. 3, 2015

(54) Document Management System and Method

(71) Applicant: Barclays Bank PLC, London (GB)

(72) Inventors: Karen Rudich, Croydon (GB); Rohit Paralikar, Mumbai (IN); Sonu Gopal Sachdeva, Pune (IN); Nishi Kant Karol, Pune (IN); Ronan Morrisey, London (GB); Ian David Sayers, Poynton (GB); Alastair John Gibson Holmes, London (GB); Charles Eugene Schwarz, Jr., London (GB); David Smith, Urmston (GB); Alexander Scandurra, Hinchley Wood (GB); Vishal Sharma, Sengkang (SG)

(21) Appl. No.: 14/431,642

(22) PCT Filed: Sep. 17, 2013
(86) PCT No.: PCT/GB2013/052428

§ 371 Date: Mar. 26, 2015

(30) Foreign Application Priority Data
Sep. 28, 2012 (GB) 1217442.1
Nov. 29, 2012 (GB) 1221509.1
May 3, 2013 (GB) 1308046.0

(51) Int. Cl. G06F 17/30; G06Q 30/04; G06F 17/24

(52) U.S. Cl. CPC G06F 17/30011; G06F 17/24; G06Q 30/04

(57) ABSTRACT

The document management system comprises a remote document repository arranged to receive and store a document; extract data from or related to the document; and perform an action based on the extracted data.

The invention relates to a document management system and method.

### BACKGROUND OF THE INVENTION

Various institutions provide document management systems allowing remote storage and access to user documents. For example, Google and Drop Box provide document management systems which are remotely accessible via the internet. Additionally various financial institutions also provide remote document storage in conjunction with vendor specialists or using their own infrastructure such as Credit Suisse and HSBC.

However known document management systems suffer from deficiencies. For example known systems have limited intelligence and so are only able to perform basic storage operations in relation to the documents. Furthermore, known systems are not able to verify documents nor perform complex transactions in relation to those documents.

### SUMMARY OF THE INVENTION

Aspects of the invention are set out in the accompanying claims.

In an aspect of the invention a document management system method of document management and a computer readable medium provide a remote document repository arranged to receive and store a document; extract data from or related to the document; and perform an action based on the extracted data.

A further embodiment of the invention provides a document management system comprising a remote document repository arranged to receive and store a document; extract data from or related to the document and reconcile the document with a related document or data.

A further embodiment of the invention provides a document management system comprising a remote document repository arranged to receive and store a document; extract data from or related to the document; and perform validation of the document.

A further embodiment of the invention provides a document management system comprising a remote document repository arranged to receive a transaction request from a first user; send the transaction request to a second user; receive confirmation that the transaction should be completed from the second user; complete the transaction; and to confirm completion to the first user.

Further, the system may provide data extracted by identifying and extracting extractable data within the document.

Further, the system may provide data extracted from metadata related to the document.

Further, the system may provide data extracted from data entered at upload of the document.

Further, the system may provide data extracted from data associated with a document proprietor or delegate.

Further, the system may provide data subjected to a pattern recognition algorithm to provide data related to likely future documents or transactions.

Further, the system may provide issuing an alert based on the extracted data.

Further, the system may provide a reminder based on the extracted data.

Further, the system may provide reconciliation, based on the extracted data, the document with a related document or data.

Further, the system may provide a bill and a statement.

Further, the system may provide completing a transaction between first and second users.

Further, the system may provide an electronic invoice transaction.

Further, the system may provide validating a document based on the extracted data to form a digital original.

Further, the system may provide validating performed based on content within the document.

Further, the system may provide validating performed based on data related to the document.

Further, the system may provide a risk level associated with the level of validation.

Further, the system may provide prompting for upload and validation of a certain type of documents.

Further, the system may provide a document rendered accessible to a document proprietor and one or more document proprietor delegates.

Further, the system may provide a document upload entity remote from the document repository. The document upload entity may be further configured to permit addition of document related data in which the additional data comprises at least one of one or more of: tags; existing documents proprietor or delegate information; and additional proprietor or delegate entered information.

Further, the system may provide the document upload entity arranged to upload the document together with metadata and encryption. The document upload entity may comprise an application loaded on a device. The document upload entity may comprise a PC/Laptop/tablet (web browser based), SmartPhone App, Kiosk or Branch, email, third party (and/or third party websites), Point of Sale (POS) terminals or government agency. In which the document upload entity comprises a dedicated scanning station.

Further, the system may provide a document handler. In which uploaded documents are checked for security and appropriateness by the document handler. In which data extracted is performed by the document handler. In which the document handler additionally validates and flattens uploaded documents.

### INTRODUCTION OF THE FIGURES

Embodiments of the invention will now be described by way of example, with reference to the drawings of which:

FIG. 1: Overview of system architecture;

FIG. 2: Flow diagram of document upload and storage;

FIG. 3: Simplified user interface screen;

FIG. 4: Flow diagram of document data enrichment;

FIG. 5: Flow diagram of document validation;

FIG. 6: Flow diagram of document processing;

FIG. 7: Flow diagram of transaction process.

FIG. 8: Architecture for digital original exchange.

FIGS. 9A and 9B: UI showing tag-based search.

FIG. 10: Flow diagram of tag-based search.

### OVERVIEW

The system according to the invention provides a one stop digital document management and storage tool connecting customers' personal information to financial data in a secure location and accessible via multiple channels allowing users to store, access, process and authenticate a range of user, and third party uploaded documents. Additionally, user transactions are facilitated via the same tool.

The system provides user interfaces for handling documents related to all aspects of user information including financial transactions and other user documents and related accounts. The system permits storage, extraction of data from or related to documents and document enrichment and dictates actions to be performed based on the extracted and enriched data. The extracted data can be content of the document itself, metadata data entered at upload or other data associated with a document proprietor or delegate. The document enrichment associates additional data with the document which can be used to provide additional functionality and can be used in reconciling documents with, for example, financial transactions. Thus the system can build up information for a customer for better targeted marketing and services and can extract derived information from documents to generate customer opportunities. Such opportunities may be presented to the user using multiple options including online banking homepage, Smart Phone App and app based notification systems, SMS/MMS, emails, regular post, and via third parties interested in the offering customers and be interactive so that the user can directly link to the opportunity and use documents stored in the user account for quick approval.

Documents may be uploaded to a document handler in a number of ways. For example, a user can scan and add documents by scanning and adding the document through a web interface. Alternatively, documents may be added directly from a financial institution account which is connected with the user document management account. Further, documents relating to financial transactions may be added at the point of receipt, for example, a corporate user of the system may have the option of providing a receipt or providing the document via email to an email address associated with the management account that may automatically forward the document to the management account or even directly to the user's document management account. In addition, documents may be provided directly by a known agent such as a corporation or government agency, for example. This allows the validation process of such documents to be speeded up as metadata for the documents will include information which allows automatic validation.

Uploaded documents pass through a document handler which performs data extraction as well as encryption, security checks and appropriateness checks. The uploaded document is then validated. Validation may include physical checks and electronic checks. Further still the document handler allows validation of documents either from information internal to the document or related external information allowing provision of digital originals with an agreed risk level allowing the documents to form the basis of further transactions without additional validation steps being required.

The digital original document comprises the document itself in digital form, the document state (for example verified, self-verified, digital copy, not verified), the document pack including owner of the pack, versioning and allowed usages and metadata for the document. The metadata can include a range of additional data including owner, allowed usages, a specific part of the document, metadata associated with the document, links to other documents, external validity links and a certificate of proof.

Based on the extracted data the management system can perform a range of actions including alerting users via, for example, SMS or email in relation to potential issues, such as the need for a payment, providing reminders within the user platform and allowing reconciliation of related documents. Further, the management system allows the user to perform specific actions, such as forwarding the document to another person or making a payment. Yet further electronic invoicing can be supported as long as the vendor is a user of the system such that immediate invoicing can be presented and completed with the transaction fully managed at and by the remote document repository. In addition a user may provide validated documents to other users of the system in support of, for example, application for approval of a new financial product such as a mortgage, setting up a new company at Companies House or for taxation purposes with HMRC.

User interaction can be performed on any appropriate remote document upload entity including PC/Laptop/tablet (web browser based), Smart Phone App, Kiosk or Branch, email, third party (and/or third party websites), Point of Sale (POS) terminals or government agency, a mobile device for storing a dedicated application, personal computer or at a dedicated scanning station for example at a financial institution location. As a result an improved data storage a management and processing arrangement is provided allowing an enhanced user life management tool.

The user may have multiple relationships, for example business (or multiple businesses) or personal and a “cloud” or document storage facility for each. Multiple users for each relationship may then access the cloud. The user can toggle between clouds they have access to.

A single user may have several document management accounts. For example, these may be linked to a personal bank account, a joint bank account and a business account for which the use is associated with. The access and permission to perform certain actions in relation to documents stored by the system can be varied according to the account and the user. Further, particular documents, stored as validated documents or digital originals, may be stored in respect of a number of selected accounts in a relevant cloud. This gives rise to multiple copies of “digital original” documents, one in each relevant management account.

The system will also include pre-configured templates or packs. The templates comprise a group of documents which can be used together and can prompt a user to upload missing specified document to these templates. For example an “Estate pack” prompts the user to upload documents related to their estate, which can then be delegated in case of an unfortunate incident of their death to both lawyers and next of kin. Similarly a

“Home Insurance pack” prompts for upload warranties and valuation documents related to the users home which can used to collate relevant documents and data. Thus, in case of fire for example, the user and provider can quickly ensure all information is included for a claim. The templates themselves can then be used for delegation and analysis of a group of documents.

Users can additionally send and verify digital original documents between one another using an exchange allowing facilitation of exchange of digital originals or document packs in an orderly and controlled manner and incorporating document/document pack specifications of the documents being exchanged permitting standardised formatting, communication and convenience. Documents and/or document packs can be added to each of the clouds that a particular user is associated with. However, the user need only upload and store each document once.

As can be seen, the approach allows a document to act as representation of data in a formalised manner suitable for interpretation or processing. Hence a digital original document can be considered as structured data for performing specific businesses or functions, containing all the information that the sender wants to deliver to the receiver system. The document can be an invoice to a customer, credit card payment instructions to a bank, driving license for identification or any other suitable type of structured document.

The document is a binary file with structured metadata information and can be represented by multiple documents, or one document may be represented multiple times in different representations. All information contained in the document in digital form, for the most part, is the same as in an original document.

The metadata itself is information that describes or identifies a piece of information. In the digital original context, the metadata is document information captured in a format such as XML for exchange of digital originals. This enables consistency and interoperability by facilitating easy exchange of structured information, where a common standard can be set up for sharing and integrating appropriate information.

Architecture

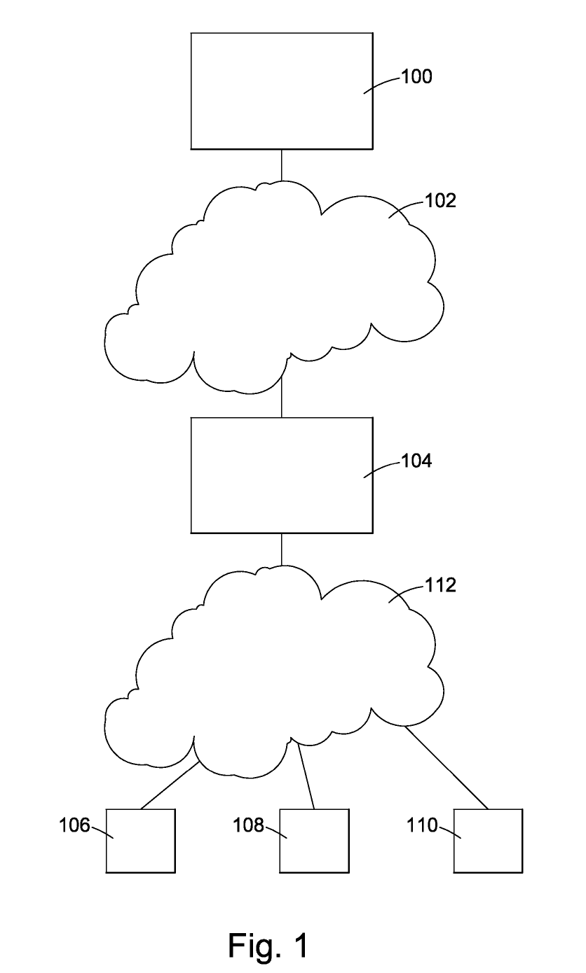

Referring to FIG. 1, principal components of the architecture can be seen. In particular a remote document repository 100 is shown which is connected either directly or through a suitable secure network 102 with a document handler 104. The document handler receives document uploads and other transaction requests from remote stations such as a mobile device or other consumer devices 106 such as a laptop, tablet, PC, smart TV or any other communication means, third party upload points 108 or government agencies 110 via a network such as the internet 112.

As a result a process and system is provided allowing both document management and transactional banking to be formed through a common, secure, consolidate resource.

Document Handling

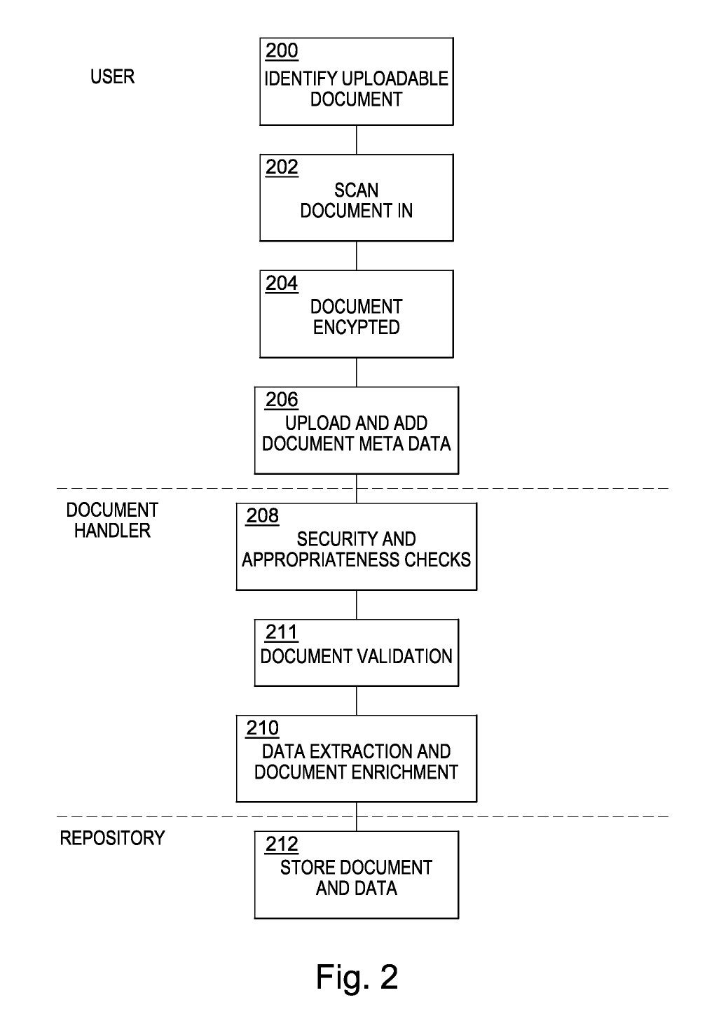

The user can upload documents from the remote data upload entity as can be seen in general terms from FIG. 2. Alternatively, documents can be added from corporations or can be generated in the system.

Upload and Users

At the step 200 the user identifies an uploadable document. This can be on a mobile device via an appropriate application on a PC either through login to the internet or a dedicated programme or at a dedicated scanning station for example at a financial institution location. Alternatively, documents are uploaded directly into a document management account. Alternatively, once drafted using a PC the user may decide to “save to document management account” directly.

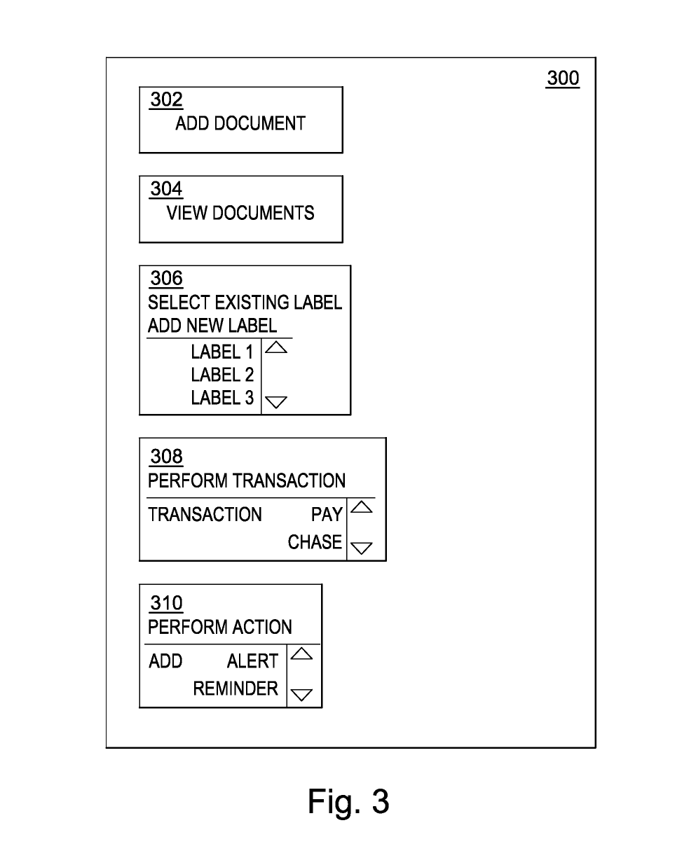

Referring to FIG. 3 a simplified sample user interface screen for document upload at the remote data upload entity is shown in more detail at 300. The UI screen can be content rich as appropriate but will be user friendly and comprehensible and may include buttons or icons operable by mouse click or touch screen, for example such as an add document button 302 which will provide guidance through the subsequent scanning stages. Additionally, the screen will include options 304 to view existing documents held by the same user or proprietor, allow selection of tags or labels to be associated with the document for example as metadata at option 306 and offer various actions and transaction options in relation to the user account and documents at 308 including for example, money transfers, payment, creating standing orders whilst managing payments and transfers, viewing existing loans, viewing existing accounts and statements and so forth. A user can decide to share access or delegate a document, a number of documents or all documents within a cloud for third parties or account to other users to view. Delegated documents or clouds may be shared for a restricted time or viewer according to the user's preference. Alternatively, if a user has more than one document management cloud, an uploaded document or pack may be added separately to each cloud or by digitally copying between clouds. Further, the user can select appropriate alerts and reminders to be associated with the document or these may be added automatically based on information within the document as data enrichment as discussed in more detail below.

Alternatively a user may upload a document simply by emailing it to a dedicated email address which can automatically extract and process documents as described herein. More generally any appropriate document ingestion point can be implemented. For example documents uploaded to, or generated in transactions with a remote provider can carry an option for upload or be automatically uploadable, such as an invoice generated by Amazon.com. Plugins can be provided in proprietary programs such as Word to permit “save to . . . ,” the document repository.

Alternatively, documents can be provided from approved corporate users of the system. For example, a particular document type can be uploaded and assigned to a user account. As will be apparent, documents from a pre-approved user can composed to ensure that the document already includes enriched data so that once it is uploaded it can immediately be reconciled with existing documents and transactions in an individual's user account. This enables alerts and reminders to be provided to the user when the document becomes available in their account and to take any action necessary, for example. Further, documents uploaded by an approved corporate user may require fewer validation checks.

Users of a particular document management cloud are not limited to an individual. For example, a single person may have a document management cloud associated with their personal accounts, including a joint account shared with their spouse and also a company cloud. That person will be the only person who can control the personal cloud, documents for the joint account will appear in the personal cloud and will also appear in the spouses' separate cloud. The personal clouds are not shared. However, several people can share the business cloud as several people will have access to the business customer ID. The access rights to the shared business cloud can be configured depending on the user. For example, the director of the company will have full rights, whereas a company administrator will be able to view documents and share labels or tags and add reminders and receive alerts but not perform transactions in relation to the documents. This is in addition to the ability of a user to delegate a limited or full set of rights to a further user(s)

Data Enrichment

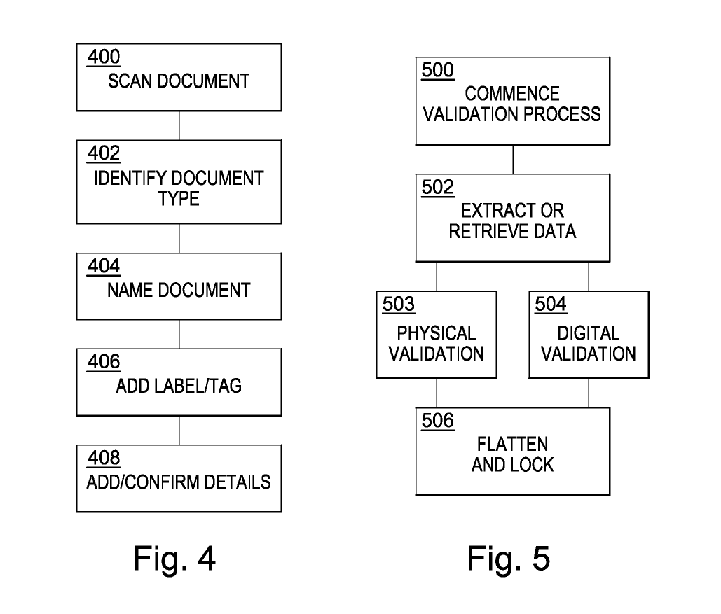

As a result, through the document upload process the user is able to enter the document at step 202 together with additional related information as shown in more detail in FIG. 4. In this exemplary approach at step 400 the document is scanned in and at step 402 the user can identify the document type either from pre-existing list or by creating a new type. The user can also name the document and add a label or tag at steps 404 and 406.

Of course it will be appreciated that the various steps can be performed in any appropriate order.

At step 408, the user may have the option to show additional information. For example some information may be extracted directly from the document. For example where the uploaded document was car insurance details then the system may automatically extract related data and suggest suitable labels or tags such as “car” in this example, and present the suggestion to the user for confirmation and addition of further information: for example any renewal dates. These tags and/or alerts may be based on important events relating to the document, related documents or the user's financial and transaction history already stored in the system. The customer can also add details such as document alerts sent via SMS or email reminding the user to renew the insurance by a deadline and reminders within the UI for performing a related action where the action is not date critical. Again, alert and reminder data may be extracted and added to the enriched document automatically. When all of the information is completed then the process can revert to FIG. 2. Users can set their own preferences for receiving alerts via multiple channels.

It will be appreciated that additional information for document enrichment can be added at the point of upload or subsequently as appropriate. For example the screen can offer a “sharing” option which will permit the document proprietor to identify delegates who may also access the document either fully or according to a preset or customised policy as appropriate.

Additionally it will be seen that data can be added at the point of scanning or subsequently. Naturally this can be done at any point by logging back into the system but additionally where the document is scanned in at a remote scanning station, especially one in a financial institution, the user can subsequently login to add appropriate information of the type discussed above. For example this can be facilitated by identifying upon re-entry into the system for new documents that have been added and permitting the information to be added accordingly.

Alternatively, where the document of known type is uploaded from a corporation, the document can already include enriched document data.

At step 204, once the document and related data have been entered/extracted from other proprietor information, the document is encrypted using any appropriate encryption mechanism and, at step 206 uploaded together with the added or related data as metadata.

The uploaded document and metadata is received via the internet 112 at the document handler 104 and at step 208 a security and appropriateness check is performed. The security check may be for example based on a virus check of any appropriate type. The appropriateness check may be based on a number of criteria such as document size, document type and content. If the check is not confirmed then the user will of course be notified appropriately.

Subsequent to upload of the document from one of multiple channels of the type described above and security and appropriateness checks 208, the handler can additionally perform data extraction from the document related data such as the metadata containing the data added or derived at entry, as shown at step 210. This allows not only document storage, but management of the document and storage of related data allowing that management. This data can then be reconciled with other documents and transactions or actions performed by the user, for example based on linking documents and data with user identification or other information.

According to the information extracted from the document and the tags added as data enrichment, this allows for the automated organisation and storage of the document in the repository. Such automation allows the system to efficiently re-locate and provide the document and information when required by a user of a subsequent visit to the user account as discussed in more detail below.

The digital original user may be granted permissions to perform actions on a specific document comprising “allowed usages”. This metadata facilitates or restricts access to documents based on the access rights set to a document by the owner, for example providing or denying access rights to people within a given organisation. Allowed usages can include: read—view contents of a document; delete—remove or delete a digital original document for example on expiry; copy—allow copying content of a document; share—this can permit third parties to share a document or metadata contained within it with other users; print—this can be applied whenever there is a need for a hard copy of the document. Metadata associated with the document can allow documents to be associated with one another based on the context of their creation or also based on the reference to an evidence of relationships shared between metadata and other documents. Hence a metadata field “associate metadata” can be provided to serve as the contained information required for specific purposes.

Additionally metadata can indicate linked documents, establishing contextual relationships between documents providing a way to identify and link documents though an ID attribute and an ID reference corresponding to a matching value. If the ID reference does not match an ID, the document will not get validated. The relationship can be a one-to-one relationship, a one-to-many relationship or a many-to-many relationship.

Additionally the metadata can define an external validity link binding metadata to data relocated remotely outside the document such as a website.

Validation

Additionally, at step 211, validation of the document is additionally provided. Referring to FIG. 5 the validation process is commenced at step 500 and at step 502 appropriate data to perform the authentication is extracted or otherwise retrieved. For example according to one approach information content from within the document is extracted and compared to ensure correlation. A copy of the document can allow for direct extraction of data 504 or the document may be physically scanned and validated with additional checks 503. For example where the document comprises a utility bill, the address, barcode, account details and so forth can be cross-checked against each other for consistency. Additionally or alternatively external data can be retrieved such as account details, corroboration from the utility company and so forth. If at step 506 validation is permitted then at step 506 the document can be flattened as a “digital original”, and locked for sending onto the repository for storage together with the original version (for example containing metadata) and related data as appropriate.

It will be noted that where the proprietor of the document has nominated a delegate in relation to the specific document, to all document of that type, or a blanket delegation, the digital copy can equally be shared by that delegate as well ensuring that the correct level of security is applied to delegation. It will further be seen that by virtue of the validation process a recorded digital paper trail is provided allowing a back-check as required.

Further, validated documents may be used in relation to new actions and transactions by the user. For example, where a user is seeking approval for a new mortgage and is required to supply proof of identify and his passport has already been validated and stored as a “digital original”, this may be delegated to the mortgage company for a limited time while the mortgage is being approved. Additionally the digital original may be provided, together with associated data, metadata and/or tags to a user's other accounts as a “digital copy” with an equal level of validity.

In one aspect, an appropriate risk level can be associated with the validation dependent on the nature or success of the validation process. For example, a validation process based purely on a physically scanned document and correlation of data within the document where there is no third party corroboration and the system merely identifies certain characteristics of the document may have a higher risk level than externally corroborated documents but this risk level may then be recognisable by third party entities in terms of the transaction by which the digital original is supported to assess whether it is sufficient verification. On the other hand, where a known document type is uploaded by an approved corporation, validation can be based on the document metadata and the risk level would be lower.

Validation can be in the form of a certificate of proof where a digital signature as part of a digital certification process provides assurance of the document's integrity, authenticity, and non-repudiation. Again this is defined as metadata using a digitally signed public key issued by a certification authority as a digital certificate certifying ownership of the public key.

The state of the document can also be indicated in the document to facilitate data interchange of digital originals. This metadata element ensures that the sender assigns one of the following attributes to each document to certify and qualify it for data interchange: verified—referring to a document that is verified by an authorised or trusted third party; self-verified—a document verified by the person whose identity it certifies; not-verified—a document which is not certified or verified by a any entity; digital copy—this can refer for example to a file containing a media product such as a film or music album.

Document Repository

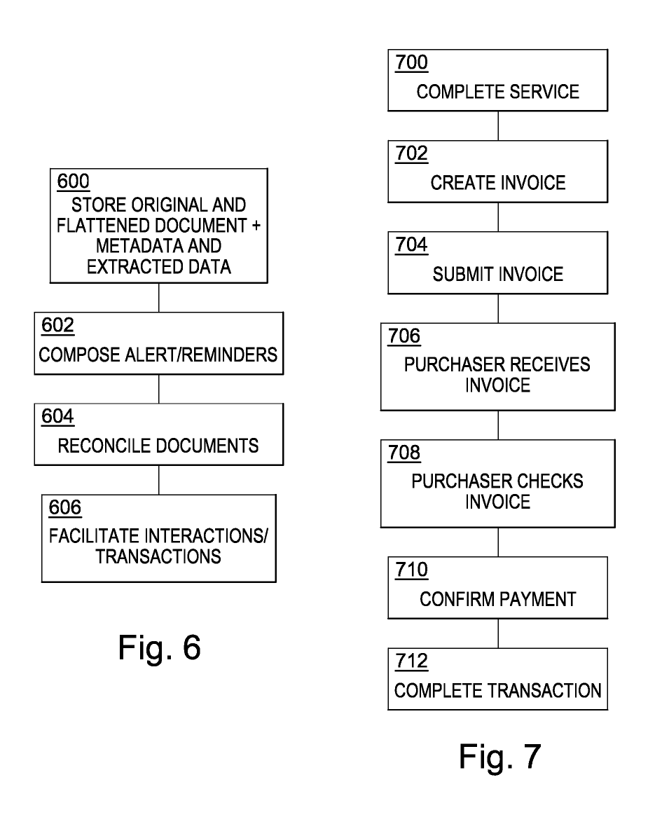

Referring now to FIG. 6, the steps performed at the document repository 100 can be further understood. At step 600 the document repository stores the original and flattened document together with related metadata, extracted data and document enrichment data. This version of online document storage provides intelligent document management capability and an intelligent cloud storage management service based on the stored documents and data. As discussed in more detail below it not only allows various services to be provided based on the information but it also allows transactions to be performed between users as well as reconciliation of documents with transactions. Of course the repository can also store user related validated documents from trusted sources, such an institution—for example a financial institution—hosting the repository.

For example at step 602 the system can compose alerts or reminders based on the data. This can be any of the extracted data from the document, enriched data from the document or information added by the user. For example as discussed above where the document comprised a car insurance certificate then this could be a date-driven alert and or reminder for the next renewal.

Alerts are generally used where action is required and the user is notified through an external means such as SMS or email. Whereas, reminders are provided when the user logs on to the system,

Alternatively alerts and reminders can be event driven. For example where the document relates to purchase of a new device, for example the invoice, this could trigger a reminder to register for the warranty or indeed could trigger automatic registration based on the information already on the system for the proprietor. Yet further, documents can be auto completed where documents can be optically read or from the unflattened version based on available information and this auto completion can be carried out automatically or offered to the user as an option. Additionally, consumer patterns can be observed and acted on. For example where invoices are uploaded and tagged then consumer spending patterns can be noted and acted on for example by presenting targeted reminders, advertisements or indicating cash flow trends, spending habits or patterns of concern.

It will be noted that the documents that can be stored and managed can be any documents related to the user rather than simply transaction documents such as identification documents, ownership documents, salary details, receipts and details of the user and their dependants and so forth. The ability to extract data from those and reconcile them, as discussed in relation to step 604, ensures that the information in the documents is used to its greatest extent and can be enriched further by importation from related information such as user address book, user maintained spreadsheets and so forth. From this data documents can be reconciled with one another and with transactions based on the rich information stored allowing automation of document management at an unprecedented level.

Related documents can be bundled together as a digital original exchange document pack such that they can be exchanged as a single unit between a sender and receiver system. An individual or organisation can attach one or more relevant documents that verify or support the information included in a specific document. Every document in the package must conform to the document structure defined in the digital original exchange specification and references herein to digital original can include either individual documents or a package as appropriate. A metadata field “document pack” permits bundling of related documents and the metadata should include individual document information, owner of the pack information, allowed usages of the pack information and document versioning information.

### EXAMPLE

In one reconciliation example, the user at separate instances uploads a direct debit instruction and a utility bill. With the direct debit instruction the user could encode data indicating what future bills this might relate to. When the utility bill is uploaded and validated the tag or data extracted from the bill itself will then permit the two documents to reconcile such that the direct debit can be automatically applied to the utility bill as intended by the user. It will be seen that many other potential reconciliation approaches can be considered. For example a hosting financial institution may also upload data to the repository to the extent that they relate to the user. These, equivalently, can include extractable data and that data can be reconciled with the user documents. For example a statement uploaded by the bank can be cross-checked against invoices loaded up by the user to ensure that all user transactions are accounted for and there are no errors in the statement.

Transactions

At step 606, a further document management capability comprises facilitation of interaction of transactions between multiple parties via the document management system. This can be understood with reference to FIG. 7. One such transaction demonstrated in FIG. 7 comprises instantaneous electronic invoicing transaction between parties comprising a vendor of a service and a purchaser of a service. The service can take any appropriate form for example a service provided by the vendor at the purchaser's home where, typically, the vendor would not have access to traditional billing capability. At step 700, the vendor completes a service and at step 702 the vendor immediately creates an invoice. This can be through interaction with, for example, an application loaded on the vendor's mobile device, tablet or laptop and can be performed by logging in to the document repository service, downloading a template invoice and completing and submitting it to the document repository. The invoice is subject to the security, appropriateness checks and validated and assuming these are passed it is then forwarded from the document repository to the purchaser. The purchaser receives the invoice at step 706 for example on their mobile or other device which provides an appropriate notification. Assuming the purchaser is also registered with the document management system, based on the notification the purchaser is invited to pay the invoice via an appropriate payment service for example by credit card, current account or the pingit ™ service offered by Barclays Bank.

At step 708 the purchaser checks the invoice which is displayed on screen and if accepted confirms payment. The payment instruction and invoice are reconciled at the document repository of the purchaser and the funds transferred between the parties as appropriate and the transaction is completed at step 712 for example sending acknowledgements to both parties. The payment is then reconciled with the invoice document in the document repository of the vendor. Additional services can be provided including chasing of the purchaser for payment. As a result a fully automated and instantaneous transaction can be managed by the document management system with minimal human interaction from the participants.

It will be noted that in the embodiment above the purchaser is also considered to be an existing user of the system but the purchaser can alternatively be a non-registered user. In that case the invoice may be received, for example via a communication means such as email which can then lead the purchaser to a log in site allowing payment through, once again, appropriate means with addition of the relevant user information.

The document management account will have stored information in relation to all of the uploaded documents. In addition to permitting reconciliation with individual transactions this information can be used to provide an overview for the user and reports which may be used to improve a service and summary information.

Where a corporation has uploaded a number of similar documents to different user accounts, the document management system can track activity in relation to the documents. For example, the corporation may be interested to know which documents were viewed by personal account users and how many times. Such summary information may be shared with the corporation and used to assess and target future products. For the user, summary reports on transactions may be useful for preparing and completing a tax return and shared directly with HMRC, once prepared, by delegating the document, for example. Yet further presented documents can additionally include targeted messages or advertisements, further enhancing the offering to the corporation.

User Interface

In addition to the user interface aspects described above, the user can usefully be provided with a summary of information on uploaded documents and transactions which have been reconciled with the documents as an interactive view in the UI. For example, this can be presented as a timestream, information stream or scrolling calendar of document activity, and transactions. This provides a running commentary and live feed of activity and also activity of third parties who have uploaded documents, and transactional information to the document management account. The UI uses a combination of text and icons to indicate the activity to the users (e.g. upload of documents, document alters, document sharing, document editing). The UI includes financial transaction history. The management system thus allows a user to quickly access and plan according to past events, interact with the stream, and perform quick actions on elements within the stream. Further the scrolling UI or calendar may be interactive allowing users to click through links to find more information in relation to a particular document or view the “digital original” for the document. For example, the user may view all document activity in August 2012 and jump to a particular document which was added by their energy suppler and check whether there was an associated financial transaction, such as paying a bill. Still further, the user view can view related document management accounts, for which they are also a user, and see the relationship between documents or transactions which are common to both accounts.

The UI may be customisable according to user preferences, thereby viewing filtered events or types of documents. Where a user has multiple relationships such as personal and business relationship, they may have a separate cloud space for each. In addition, where a user has multiple clouds such as a personal and business cloud, he may switch or ‘toggle’ between them. For example, the UI may provide an icon or link as a direct link to another cloud from the UI of a first cloud. Thus, a user can quickly view all of their clouds and toggle into the cloud to see related transactions or documents for the cloud they have toggled into.

Further, the scrolling through the UI calendar can be extended to include future events. This provides a calendar for known future events according to document alters. The tool can also be used to predict future events. For example, using pattern recognition, the management system can predict future events such as receiving a monthly bill for a subscription service. The management system can reconcile this document information with banking account information so that a user can be provided with a prediction of the funds available on the date that payment of the bill will be due. This provides users with a useful tool of managing cash flow which enables action to be taken in advance of future issues.

Both historic events and future events in the calendar are interactive. Users are enables to link to events and documents to perform certain actions related to their documents and transactions.

Search

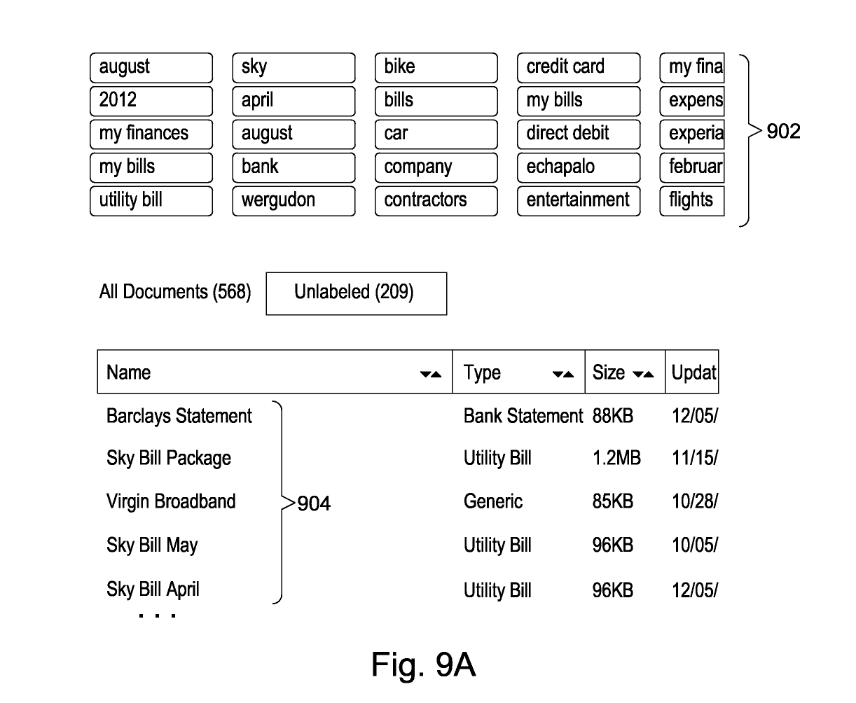

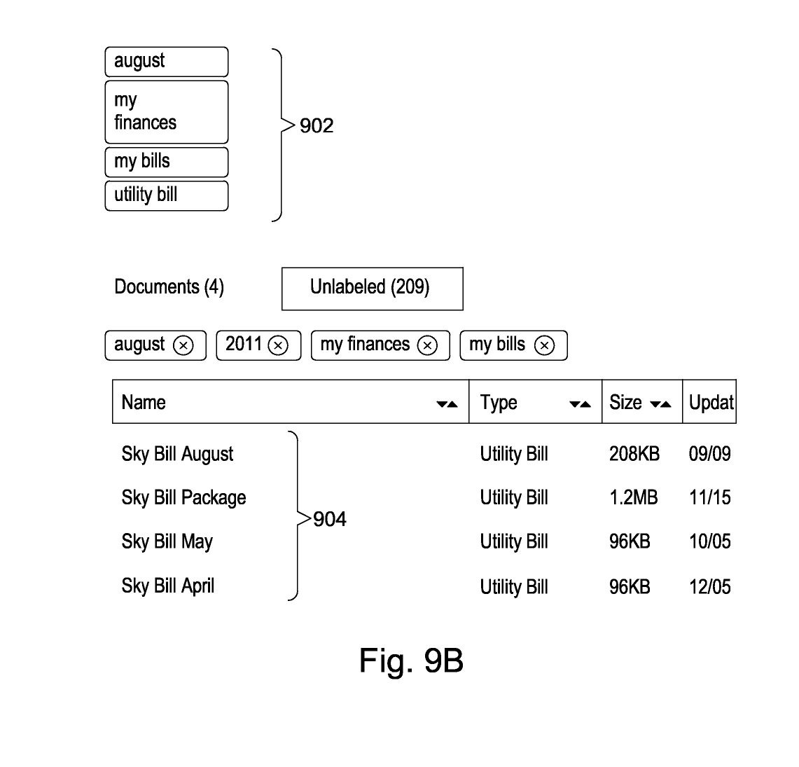

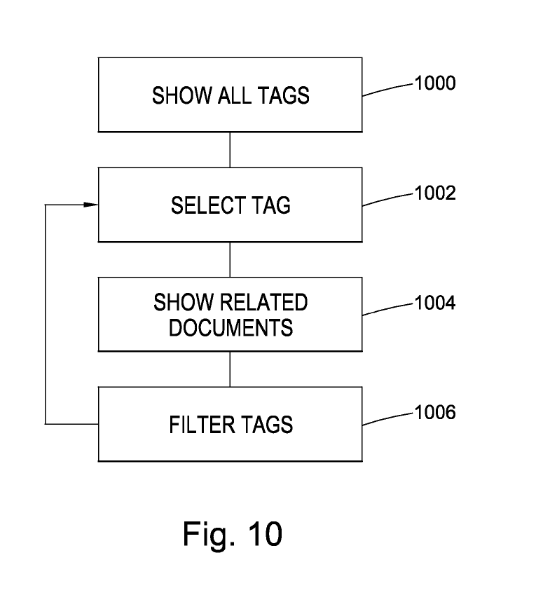

In another view of the UI shown in FIGS. 9A and 9B and FIG. 10 the user is presented at step 1000 with a list of all their existing tags 902 relating to their documents 904. A first tag type may be selected, at step 1002 at which point the UI will list at step 1004 all of the documents which are related to that tag. The list of documents can link to the digital original and related documents. The list of documents can be further filtered by selecting additional tags. In real-time, the number of documents in the list are decreased. Importantly at step 1006 the tag list is edited in real time as well, as shown in FIG. 9B, retaining only those tags associated with the remaining documents. Hence, the number of available tags also decreases as not all of the remaining tags will be associated with the remaining documents. Thus, the available document are “dual filtered”. This approach allows for quick filtering to find a particular document, and rapid “drilling down” of the relevant tags or search terms.

Document Exchange

According to one aspect, once digital originals have been created they can form the basis of transactions of document entities such as digital originals and associated document exchange specifications or document packs between multiple users or clouds associated with a single user by virtue of a digital original exchange. In order to facilitate exchange of digital original documents between two or more parties a digital original exchange specification further defines the specifications that need to be adhered to including the vocabularies, document representation and packaging for the exchange. As a result it is not necessary for individual parties to agree a format as this is fully standardised.

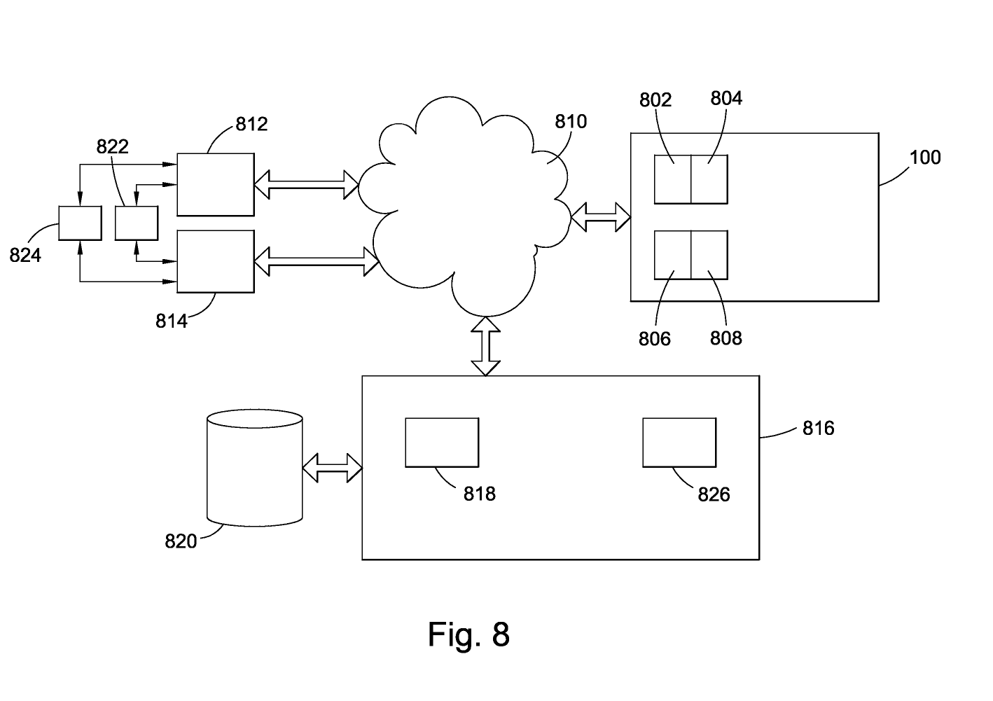

Referring to FIG. 8, the architecture of such a system is shown in more detail.

The document repository 100 includes one or more digital originals 802 together with related digital original specifications 804. The digital original can comprise any appropriate copy document as discussed above, preferably verified as appropriate. The specification can be linked directly with the digital original or can be retrievable for example based on an identifier or address provided in the metadata attached to the digital original. The specification can be automatically compiled for the digital original or can require additional manual input upon creation of the digital original as appropriate.

In particular the digital original 802 and specification 804 can include the document itself in a digital form as discussed above together with the specification data included as metadata or otherwise accessible again as indicated above. The specification can include, for example, owner data, data regarding allowed usages such as freedom of copying, reference to data elements which are part of the documents (for example components sub-documents), data elements associated with the documents (for example other associated documents or metadata), links to other documents allowing those documents to be pulled on demand “through” the digital original and links allowing external validation for example indication from a trusted third party that the document has been validated or verified to the appropriate level of trust.

In addition to content-related data, data relating to state of the document can be stored with the metadata or otherwise, for example indicating that it is self verified or that it is verified by an agency for example carrying identification of a certifying authority, or indicating that it is un-verified or indicating that it is a digital copy, for example, a non-verified copy of a verified original. As will be seen, by providing this data in association with the digital original itself, exchange of digital originals can be facilitated.

In order to store, control and permit authorised updates to the document specification a document specification authority 826 is additionally provided. In automated creation of document specifications the authority 826 can provide the format, template or operating instructions governing the process ensuring full standardisation and compliance. Any changes or additions to the form or agreed content of the document specification is thus only possible with appropriate permissions at the authority 826.

In addition to digital originals, the document repository may also store document packs of the type described generally above. The document pack is shown at 806 as comprising a collection of digital originals, or links to digital originals, associated with a document pack specification 808. The document pack specification can include, for example, identification of each of the documents forming the document pack, identification of owner of the pack and allowed usages for example copying permissions or permissions to split the pack into individual documents for individual use. Document packs may contain all of the documents that are required to complete a certain process or action, for example, an application for a mortgage or a tax return submission. The pack is populated with customer information and contains the necessary validated documents. Once a pack is confirmed as complete and correct, the customer may use the pack to exchange. The pack may have some slots that will only accept certain documents which will need to be added to the account to complete the pack if not already part of the account. Again, as can be seen from the discussion below, this permits exchange of both digital originals and the document packs between users with enhanced levels of simplified and systematised verification.

The document repository 100 communicates with other components in any appropriate manner, for example directly, or as shown in FIG. 8 through the internet or other network 810. For example the document repository can communicate with one or more users 812, 814 as well as a digital original exchange 816.

The digital original exchange can carry a range of functions 818 permitting users to exchange documents and apply other functionality as available. The functions 818 can include registration to the exchange allowing providers and consumers of digital originals to be listed together with associated information; this can be nationally based or otherwise implemented as appropriate taking into account local regulatory requirements. Buying and selling of digital originals or document packs can be facilitated between users. Similarly auctions of digital originals and document packs can be facilitated by the exchange functionality for example allowing a customer to auction its monthly bills to a bill collector. Additional operations of either self-service or managed operations can additionally be presented as functionality for all functions of the exchange. Settlement functions can be offered allowing participants to settle exchanges.

The settlement function ensures reconciliation of transactions between users of the document exchange, for example completing payment by a consumer-user to a provider-user of a digital original. For example where a consumer has bought a set of digital originals from a provider the provider must get the relevant payment from the consumer. This is considered a settlement of the transactions, and which must be performed irrespective of the size or number of transactions.

The settlement in terms of payments can be performed using any payment method available. As part of the registration process with the system, settlement method and associated details are captured to provide quick settlement against transactions.

The exchange may allow enrichment of data regarding specific participants by providing a ratings service to provide a rating per participant for example based on reliability or trustworthiness which can enhance both the exchange process and the certification or verification process. Yet further, a search capability can be provided allowing search of digital originals. Additionally, control may be handed to the digital original owner relating to whether the document is searched or searchable and this data can be stored against the document and/or against the user as appropriate. Further, the owner may reduce parts of the document using digital editing to protect certain parts or the document. The owner can share the reduced digital original. The third party would be assured that the document is authentic and original despite reduction of certain parts. Finally, for management purposes, a reporting function is available for example allowing quarterly reporting of exchange information at any appropriate level of granularity for example the number of digital originals exchanged, or more sophisticated data as appropriate. As a result, and in conjunction with the use of the digital original exchange specifications, transactions based on the digital originals can be facilitated, controlled and provided in a range of functionalities as appropriate.

Further associated with or forming part of the digital original exchange 816 is a database or other data repository 820 storing listings of providers and consumers of digital originals or document packs, allowing registration of the relevant party together with related information including rating information based on their track record and potentially other information such as permissions for copying, searching and so forth.

The datastore 820 can use any standard database connectivity mechanism e.g. ODBC, JDBC. The datastore 820 stores all the information/data required for the functioning of the exchange.

Based on the functionality of the digital original exchange, and the information contained in the digital original/document pack specifications, digital originals and copies can be exchanged between users 812, 814. It will be noted that the users can comprise any appropriate type including consumers, corporate entities, financial institutions, traders and brokers, retailers and agencies. Two users are shown in the FIG. 8, by way of example, but of course any appropriate number of users can be attached and involved.

When a digital original 802 or document pack 806 is exchanged between two users 812, 814, it can be sent either directly between them, retrieved from the document repository by the sender, or can be sent via an instruction to the document repository from the sender to forward the document to the user. At the same time the corresponding specification 804, 808 for the digital original or document pack is also sent from the sender 812 to the receiver 814 either in a direct transaction or via the internet 810. Again, alternatively, the sender can send the specification to the receiver using an appropriate instruction to the document repository or digital original exchange 816.

Where the document sender relies on an internal representation of the document to be sent to another party it is converted as per the digital original exchange specification and sent to the party in conjunction with the specification itself. The conversion comprises setting the semantic structure of the document to the conventions required by the document specification. E.g. document D1 owned by Provider A has the metadata owner: Provider A, which is their internal representation of this metadata. Since the document exchange specification defines all the metadata associated with the document which in the case of “owner” metadata has been defined as <Owner></Owner>, then before sending the document out to another user or the exchange, Provider A will have to convert the owner information as per the standard i.e. from owner: Provider A to <Owner>Provider A>/Owner>. The document receiver uses the digital original exchange specification to validate the incoming document and ensure that it is in accordance with the digital original exchange specification standard allowing the document receiver then to use the document as required. It will be seen that the document can be an existing document stored at the repository, a document (digital original and specification) created in real-time or a batch of either.

As will be seen, therefore, the flexibility of use of the digital originals is significantly enhanced whilst still allowing a systematised, secure and user friendly exchange mechanism.

Variations

It will additionally be seen that the validation approaches described herein can provide additional levels of certainty and security for users of the system. For example the invoice uploaded by the vendor can be authenticated according to the techniques described above such that it is verified to the receiving purchaser prior to payment. As a result of the approach described, it will be seen that a highly simplified, automated and trustworthy financial transaction and document storage management process is permitted.

It will be appreciated that the approach as described herein can be implemented in any appropriate manner. The remote devices can be of any appropriate type including portable or fixed or proprietary devices as appropriate, and the routines and storage mechanisms can be implemented in software, firmware or hardware as appropriate. Similarly the document handler and storage repository can be implemented in any appropriate manner including software, firmware or hardware.

Although some of this disclosure is directed toward financial transactions it will be appreciated that the approach as described herein apply equally to any form of transaction where documents in related data can be stored and data extracted therefrom to permit subsequent actions to be performed.

1. A document management system comprising:
a remote document repository arranged to receive and store a document;
extract data from or related to the document; and
perform an action based on the extracted data.

2. A document management system comprising a remote document repository arranged to receive and store a document;
extract data from or related to the document and reconcile the document with a related document or data.

3. A document management system comprising a remote document repository arranged to receive and store a document;
extract data from or related to the document; and
perform validation of the document.

4. A document management system comprising a remote document repository arranged to receive a transaction request from a first user;
send the transaction request to a second user;
receive confirmation that the transaction should be completed from the second user;
complete the transaction; and
confirm completion to the first user.

5. A system as claimed in claim 4 in which the transaction comprises an electronic invoice.

6. A system as claimed in any preceding claim in which data extracted by identifying and extracting extractable data within the document.

7. A system as claimed in any preceding claim in which data extracted from metadata related to the document.

8. A system as claimed in any preceding claim in which data extracted from data entered at upload of the document.

9. A system as claimed in any preceding claim in which data extracted from data associated with a document proprietor or delegate.

10. A system as claimed in any preceding claim in which extracted data subjected to a pattern recognition algorithm to provide data related to likely future documents or transactions.

11. A system as claimed in any preceding claim arranged to issuing an alert based on the extracted data.

12. A system as claimed in any preceding claim arranged to providing a reminder based on the extracted data.

13. A system as claimed in any preceding claim arranged to reconciliation, based on the extracted data, the document with a related document or data.

14. A system as claimed in claim 13 in which the reconciled documents comprise a bill and a statement.

15. A system as claimed in any preceding claim further arranged to completing a transaction between first and second users.

16. A system as claimed in claim 15 in which the transaction comprises an electronic invoice transaction.

17. A system as claimed in any preceding claim arranged to validating a document based on the extracted data to form a digital original.

18. A system as claimed in claim 17 in which validating is performed based on content within the document.

19. A system as claimed in claim 17 in which validating is performed based on data related to the document.

20. A system as claimed in any of claims 17 to 19 further comprising a risk level associated with the level of validation.

21. A system as claimed in any of the preceding claims further comprising a prompting for upload and validation of a certain type of documents.

22. A system as claimed in any preceding claim in which a document rendered accessible to a document proprietor and one or more document proprietor delegates.

23. A system as claimed in any preceding claim further comprising a document upload entity remote from the document repository.

24. A system as claimed in claim 23 in which the document upload entity is further configured to permit addition of document related data.

25. A system as claimed in claim 23 in which the additional data comprises at least one of one or more of:
tags;
existing documents proprietor or delegate information; and
additional proprietor or delegate entered information.

26. A system as claimed in any of claims 23 to 25 in which the document upload entity is arranged to upload the document together with metadata and encryption.

27. A system as claimed in any of claims 23 to 26 in which the document upload entity comprises an application loaded on a device.

28. A system as claimed in any of claims 22 to 27 in which the document upload entity comprises a PC/Laptop/tablet (web browser based), Smart Phone App, Kiosk or Branch, email, third party (and/or third party websites) Point of Sale (POS) terminals or government agency.

29. A system as claimed in any of claims 22 to 28 in which the document upload entity comprises a dedicated scanning station.

30. A system as claimed in any preceding claim in which the remote document repository further includes a document handler.

31. A system as claimed in claim 30 in which uploaded documents are checked for security and appropriateness by the document handler.

32. A system as claimed in claim 30 or claim 31 in which data extracted is performed by the document handler.

33. A system as claimed in any of claims 30 to 32 in which the document handler additionally validates and flattens uploaded documents.

34. A document management system comprising a document repository arranged to store a document entity and a document entity specification specifying a parameter of the document; and
a document exchange platform arranged to permit first and second remote users to exchange stored documents and document specifications for verification of exchanged documents.

35. A system as claimed in claim 34 in which the document exchange platform stores user data.

36. A system as claimed in claim 34 or claim 35 in which the document exchange platform further comprises at least one of the following functionality group;
user registration;
user rating;
buy/sell of documents;
search documents;
settlement between users;
reporting of document exchanges;
document auction.

37. A system as claimed in any of claims 34 to 36 in which the document exchange platform further stores permissions and associated data related to users.

38. A system as claimed in any of claims 34 to 37 in which the associated data for the document entity is stored as document entity metadata.

39. A system as claimed in any of claims 34 to 38 in which the data associated with the document entity comprises at least one of the group of:
owner data;
allowed usage;
data elements of the document entity;
data elements associated with the document entity;
a link to another document entity;
external verification data;
verification status of the document entity;
copy permission for the document entity.

40. A system as claimed in any of claims 34 to 39 in which the document entity comprises at least one of a digital original or a document pack of digital originals.

41. A system as claimed in claim 40 further comprising storage of a document pack of documents and a document pack specification.

42. A system as claimed in claim 40 or 41 in which the document pack specification further includes document pack owner data and allowed document or document pack usage data.

43. As system as claimed in any of claims 34 to 42 further comprising a document specification authority storing specification format data.

44. A system as claimed in any of claims 34 to 43 further arranged to settle payment between users for exchanged document entities.

45. A system as claimed in any preceding claim, wherein a user is associated with multiple clouds and a user interface allows the user to toggle between clouds.

46. A method of document management comprising storing a document and associated document specification data in a document repository, exchanging the document between first and second remote users, exchanging the associated document specification between the users and verifying the exchange based on the document specification.

47. A method of document management comprising:
receiving a document;
receiving and storing the document in a remote document repository;
extracting data from or related to the document; and
performing an action based on the extracted data.

48. A method of document management according to claim 46 further comprising any of the steps according to claims 2 to 44.

49. A method of searching data entities having associated tags, the method comprising displaying a set of tags, displaying data entities corresponding to a selected tag, and displaying only tags associated with the displayed data entities for subsequent selection.

50. A computer readable medium arranged to perform the steps of the document management system of claims 1 to 44 or the method of claims 46 to 49.
